(19) United States
(12) Patent Application Publication
(10) Pub. No.: US 2025/0284817 A1
(43) Pub. Date: Sep. 11, 2025

(54) CHANGE-INCIDENT LINKAGES AND CHANGE RISK ASSESSMENT GUIDED THROUGH CONVERSATIONS

(71) Applicant: INTERNATIONAL BUSINESS MACHINES CORPORATION, ARMONK, NY (US)

(72) Inventors: Amar Prakash Azad, Bangalore (IN); Harshit Kumar, Delhi (IN); Michael Elton Nidd, Zurich (CH); Yu Deng, Yorktown Heights, NY (US); Prateeti Mohapatra, Bangalore (IN); Paulina Toro Isaza, White Plains, NY (US); Larisa Shwartz, Greenwich, CT (US)

(21) Appl. No.: 18/600,694

(22) Filed: Mar. 9, 2024

(51) Int. Cl. G06F 21/57

(52) U.S. Cl. CPC G06F 21/577; G06F 2221/034

(57) ABSTRACT

Change incident data in an enterprise computing system may be linked to other data in conversations. The link creation includes receiving electronic conversations associated with an issue in the enterprise computing system. A change request is identified in electronic conversations. An incident number is identified in the electronic conversations. A first link is generated associating the change request to the incident number. The first link is applied to a downstream application.

### BACKGROUND

### Technical Field

The present disclosure generally relates to computing arrangements based on specific computational models, and more particularly, to change-incident linkages and change risk assessment in computing systems guided through conversations.

### Description of the Related Art

In many software systems, there exists an administrative function that addresses incidents. Incidents are typically reported by a user but reporting sometimes occurs via an automated function. Some end users (for example, a software developer or an administrative user) may initiate a process to address the incident via a change request. In a typical change request process, a conversation may take place where the reporting party of the incident may describe incident details, provide notes, or document actions taken. In a conventional process, an incident is addressed discretely from other incidents. Change requests related to the incident may be implemented with little forecast on the impact or risk of the change request to the software system.

A conversation generally includes information about the issue that is being discussed. The issues may be tied to a change request that caused the issue. Some conversations indicate symptoms related to the issue. Follow-up conversations may include investigations and findings related to the issue. Conversations may also include descriptions of resolutions and actions related to the issue.

### SUMMARY

According to an embodiment of the present disclosure, a non-transitory computer readable storage medium tangibly embodying a computer readable program code having computer readable instructions is provided that, when executed, causes a computer device to carry out a method of linking change incident data in an enterprise computing system. The method includes receiving one or more electronic conversations associated with an issue in the enterprise computing system. A change request is identified in the one or more electronic conversations. An incident number is identified in the one or more electronic conversations. A first link is generated associating the change request to the incident number. The first link is applied to a downstream application.

According to an embodiment of the present disclosure, a computer implemented method for linking change incident data in an enterprise computing system includes receiving, by a change incident computing engine, one or more electronic conversations associated with an issue in the enterprise computing system. A change request is identified in the one or more electronic conversations. An incident number is identified in the one or more electronic conversations. A first link is generated associating the change request to the incident number. The first link is applied to a downstream application.

According to an embodiment of the present disclosure, a computing device is configured to link change incident data in an enterprise computing system. The computing device includes a processor. A storage device is coupled to the processor. An engine is stored in the storage device. An execution of the engine by the processor configures the computing device to perform acts including receiving, by the change incident computing engine, one or more electronic conversations associated with an issue in the enterprise computing system. A change request is identified in the one or more electronic conversations. An incident number is identified in the one or more electronic conversations. A first link is generated associating the change request to the incident number. The first link is applied to a downstream application.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block diagram of a computing environment for linking change incident data in an enterprise computing system, consistent with an illustrative embodiment.

FIG. 2 is a block diagram of an enterprise computing system for linking change incident data, consistent with an illustrative embodiment.

FIG. 3 is a block diagram of an architecture for linking change incident data in an enterprise computing system, consistent with an illustrative embodiment.

FIG. 4 is a flowchart of a method for linking change incident data via explicit identification of objects in electronic conversations within an enterprise computing system, consistent with an illustrative embodiment.

FIG. 5 is a flowchart of a method for linking change incident data via implicit identification of objects in electronic conversations within an enterprise computing system, consistent with an illustrative embodiment.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

### Definitions

Module, as used herein, refers to a software application, which may be standalone or may be a hardware component that includes the software application programmed into memory or a circuit.

Enterprise Computing System, as used herein, refers to a software system or a computing system that is used by multiple entities in a company and may involve multiple applications. Examples include software development platforms, administration management platforms, collaboration platforms between departments, and so on.

Natural Language Processing, as used herein, refers to an artificial intelligence application using computational linguistics—rule-based modeling of human language—with statistical, machine learning, and deep learning models to enable computers to process human language in the form of text or voice data and to ‘understand’ its full meaning, complete with the speaker or writer's intent and sentiment.

Change Request, as used herein, refers to a request to modify one or more elements in a software system or computing system.

Pull Request, as used herein, refers to a formal request to make a change request implemented into a staging area.

Conversation, as used herein, refers to electronic communications that include reporting of issues in a software system or computing system, discussions between an administrator and the reporter of an issue, discussions between administrators of the software or computing system in association with rectifying the issue, and notes related to the issue and fixes of the issue.

Link or linkage, as used herein, refers to a relationship established between two or more elements of conversations.

Downstream Application, as used herein, refers to uses of links/linkages in practical applications including for example, pull request risk prediction/modelling, change request risk prediction/modelling, change similarity, and action/extraction from change request.

Resolution, as used herein, refers to a solution applied to a reported issue or a final action implemented in response to a reported issue.

Change Number, as used herein, refers to a number automatically assigned to a modification in the computing system.

Incident Number, as used herein, refers to a number automatically assigned to a reported issue in the computing system.

Service Incident Number, as used herein, refers to a number automatically assigned to an instance of a service handling a request or reported issue.

Unstructured Text, as used herein, refers to text in a conversation that is not pre-identified by a metadata tag.

Symptom, as used herein, refers to text in a conversation that describes an undesirable condition associated with an issue.

Multi-hop, as used herein, refers to extracting data from more than one source (e.g., platform or service) of conversation.

Ground Truth Data, as used herein, refers to the accuracy of a training set's classification for supervised learning techniques.

### Overview

The present disclosure generally relates to software development and management systems. Embodiments of the subject technology provide improvements to automating the identification of causes of incidents in a software system along with the impact or riskiness a change request related to an incident brings to the software system.

In the field of reviewing change requests and maintaining software systems, challenges are present in evaluating the impact and riskiness of change requests or changes put into action in the software system. Once change requests are implemented, unintended consequences may occur in the system. Currently, with change requests being treated as discrete events, there is a challenge in identifying the relationship between one change request and other elements that are explicitly or implicitly connected to the change request. One challenge facing system administrators is tracking what other elements in a conversation are tied to any one change request. Other elements related to a change request may include important clues that can be analyzed. The clues and relationships may be used in downstream applications to predict risk to the system.

In some cases, not all conversations include data that is explicitly tagged or linked to incidents or changes. Unless a change or other data point is specifically tagged by a user, much of the data in a conversation is unstructured text. Some change conversations (CR subset) include an explicit link to a change request but may not be linked with an incident reference number, which makes tracking and linking one conversation to another conversation a challenge. Incident conversations (a type of incident data subset) may include explicit incidents but may not have a change request reference identification number. Very few conversations in the software system may include both a change request and an associated incident reference identification number. When discussion of a change spans across multiple conversation platforms (for example, for a customer service helpdesk to an administrative team collaborative platform), the identification number formats may not match.

In the subject technology, links may be generated between change requests and events or information associated with change requests. Moreover, data contributing to the effect or impact of the change request may be learned from conversations associated with the change request. In some embodiments, the associated data may be learned from explicit data mining that gathers tagged metadata from the text of conversations. In some embodiments, the associated data may be learned through implicit data mining of unstructured text. A natural language processing module is used by artificial intelligence to determine the presence of data in conversations that can be used to make associations between a change request in one conversation and other associated data that is in the same conversation or in conversations from a different source. As will be appreciated, the links generated from the processes described herein are valuable to prepare ground truth data for training A.I. models.

As will be appreciated, while many of the elements in the subject technology are software-based, the processes involved provide an improvement to computing technology; namely identifying the links between change requests and other data that can be used for predictive modelling of impacts and risk on a software system. It should be further appreciated that aspects of the teachings herein are beyond the capability of a human mind since change request data is gathered from several sources and often in non-human language. It should also be appreciated that the various embodiments of the subject disclosure described herein include information that is impossible to obtain manually by an entity, such as a human user. Moreover, the links generated improve on the ground truth data for machine learning processes that will be used in downstream applications for improving the operating health of the software system.

### Example Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one or more storage devices that may include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 includes an example of an environment for the execution of at least some of the computer code involved in performing the inventive methods, such as the improved code 200. The improved code 200 may include a change incident linkage and risk assessment engine 240 that identifies data from conversations pertaining to a change request and generates links between the change request and associated data. The change incident linkage and risk assessment engine 240 may operate according to one or more of the methods disclosed in further detail below. In addition to code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

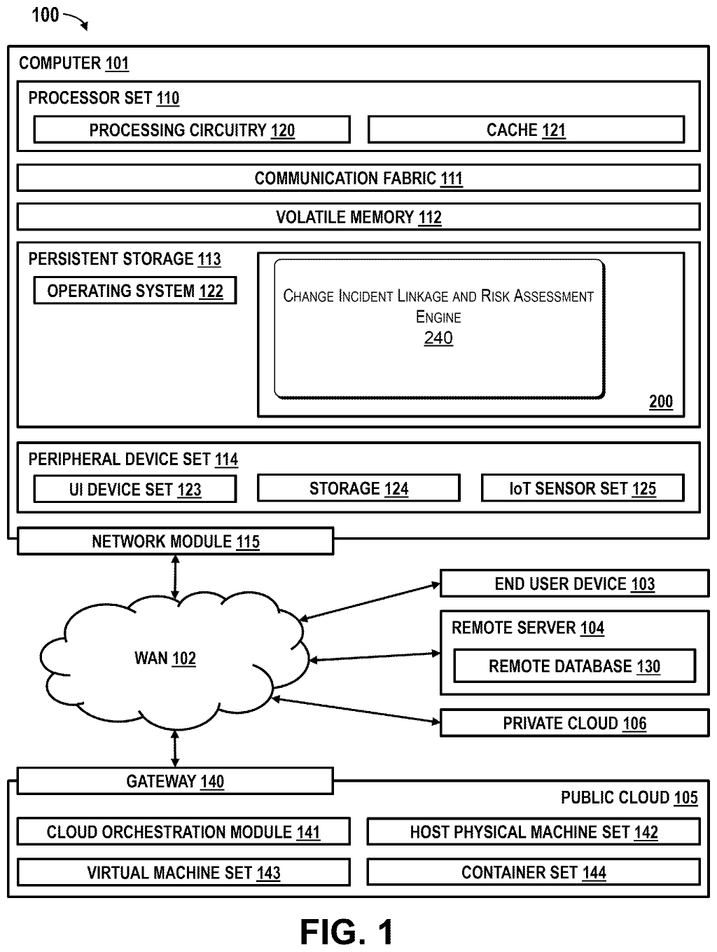

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. For the instant disclosure, the processor set 110 includes for example a central processing unit (CPU) and an accelerator. In some embodiments, a different type of processing element may be used instead of the CPU, (for example, a GPU or other process dedicated/specialized unit). Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Example System Architecture

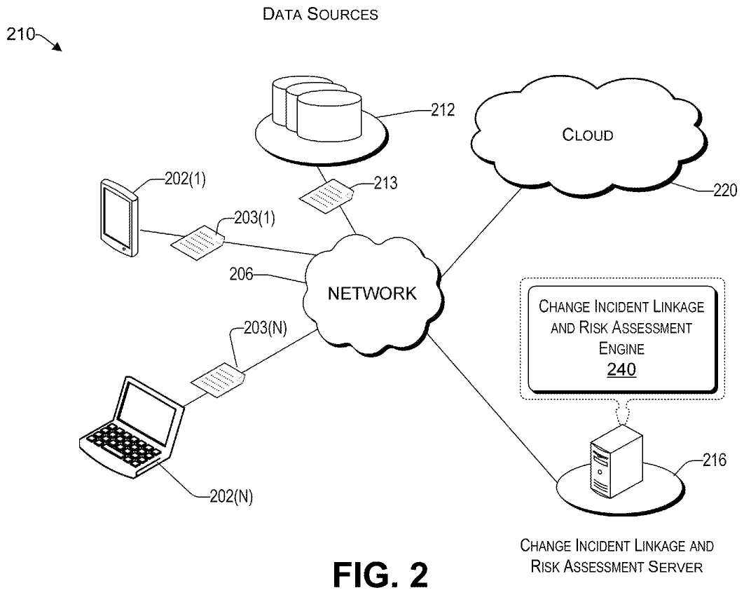

FIG. 2 illustrates an example architecture 210 for linking change incident data in computing systems. In some embodiments, the computing systems may be enterprise level systems. Architecture 210 includes a network 206 that allows various computing devices 202(1) to 202(N) to communicate with each other, as well as other elements that are connected to the network 206, such as data source 212, a change incident linkage and risk assessment server 216, and the cloud 220. The computing devices 202(1) to 202(N) and change incident linkage and risk assessment server 216 may operate under the computing environment described above in FIG. 1. The change incident linkage and risk assessment server 216 may operate the code 200, including the module for the change incident linkage and risk assessment engine 240. The change incident linkage and risk assessment engine 240 may be configured to generate links between change request identifiers and change request related data, in the change incident linkage and risk assessment server 216. In addition, the change incident linkage and risk assessment engine 240 may generate predictive models that predict risk and/or impact of a change request on the software system based on relationships between a change request and the effect of actions found in the associated data.

The network 206 may be, without limitation, a local area network (“LAN”), a virtual private network (“VPN”), a cellular network, the Internet, or a combination thereof. For example, the network 206 may include a mobile network that is communicatively coupled to a private network, sometimes referred to as an intranet that provides various ancillary services, such as communication with various application stores, libraries, and the Internet. The network 206 allows the change incident linkage and risk assessment engine 240, which is a software program running on change incident linkage and risk assessment server 216, to communicate with the data source 212, computing devices 202(1) to 202(N), and/or the cloud 220, to provide data linkages and predictive modelling. The data source 212 may include source data gathered or extracted from conversations. In some embodiments, the data source 212 may include historical records of actions taken in association with archived conversations that a model may use to replicate the impact and/or risk to the software system posed by data found in the conversations. In some embodiments, a data packet 213 may be received by the change incident linkage and risk assessment engine 240. This data packet 213 can be received by the change incident linkage and risk assessment engine 240 by either a push operation from the data source 212 or from a pull operation of the change incident linkage and risk assessment engine 240. In one embodiment, the data processing is performed at least in part on the cloud 220.

For purposes of later discussion, several user devices appear in the drawing, to represent some examples of the computing devices that may be the source of data being analyzed depending on the task chosen. Aspects of the symbolic sequence data (e.g., 203(1) and 203(N)) may be communicated over the network 206 with the change incident linkage and risk assessment engine 240 of the software component move and transform server 216. Today, user devices typically take the form of portable handsets, smart-phones, tablet computers, personal digital assistants (PDAs), and smart watches, although they may be implemented in other form factors, including consumer, and business electronic devices. While the data source 212 and the change incident linkage and risk assessment engine 240 are illustrated by way of example to be on different platforms, it will be understood that in various embodiments, the data source 212 and the software component move and transform server 216 may be combined. In other embodiments, these computing platforms may be implemented by virtual computing devices in the form of virtual machines or software containers that are hosted in a cloud 220, thereby providing an elastic architecture for processing and storage.

### Example Change Request Linking Architecture

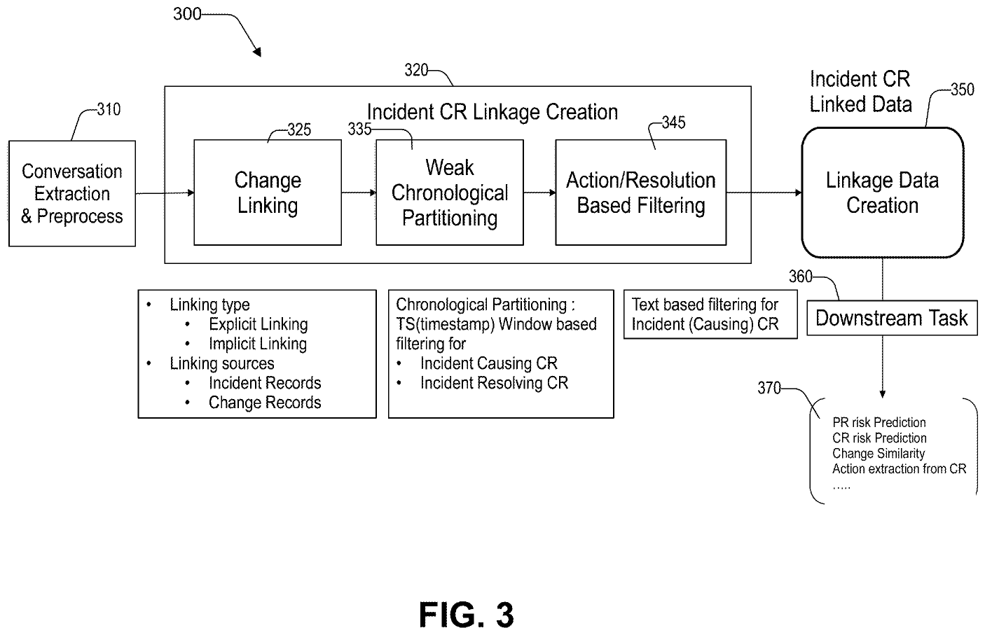

FIG. 3 shows an architecture 300 for creating links associated with change requests. The architecture 300 may include a pre-processing module 310 that extracts metadata from electronic conversations. The conversations may be obtained from multiple sources (for example, different platforms, different chat services, different interactive record services (e.g. git issues), etc.). An incident change request linkage creation module 320 receives the metadata from the pre-processing module 310 and creates links that show connections between the instances referring to a change request and other data that is associated with the change request. A change linking module 325 may identify a change request and conversations related to the change request. Being “related” to a change request may mean that data infers or implies some action or event that occurs as a result of a change request implementation. The linking may be either explicit or implicit. Explicit links may be identified from conversation data that explicitly identifies a change request. Implicit links may be identified by analyzing inferences made in conversations that can be estimated as being related to a change request. Examples of sources for obtaining linking data include incident records and change records. A weak chronological partitioning module 335 may establish time stamp windows for conversations and actions related to change request events. The windows may be portioned by filtering conversation data for incidents causing a change request and for incidents that show a resolution to a change request. An action/resolution filtering module 345 may filter text for incidents causing change requests. From the data generated by the linkage creation module 320, a linkage data creation module 350 may generate links establishing connections between change requests and events/actions in conversations associated with the change requests. The events/actions may be indirectly related; for example, may include effects to the software system that were triggered, whether anticipated or unintended, as a result of the change request. Once the links are created, the architecture 300 may forward the link data to a downstream task 360 such that can be used in different applications. Examples of downstream applications 370 in the architecture 300 that use the links include pull request risk prediction modelling, change request risk prediction modelling, change similarity modelling, action extraction machine learning from the change request conversations, etc.

### Example Methodology

In the methods below, reference numerals are attached to actions in the steps described. Other enumeration may reference back to one or more elements (that may be objects or system components) in the previous figures.

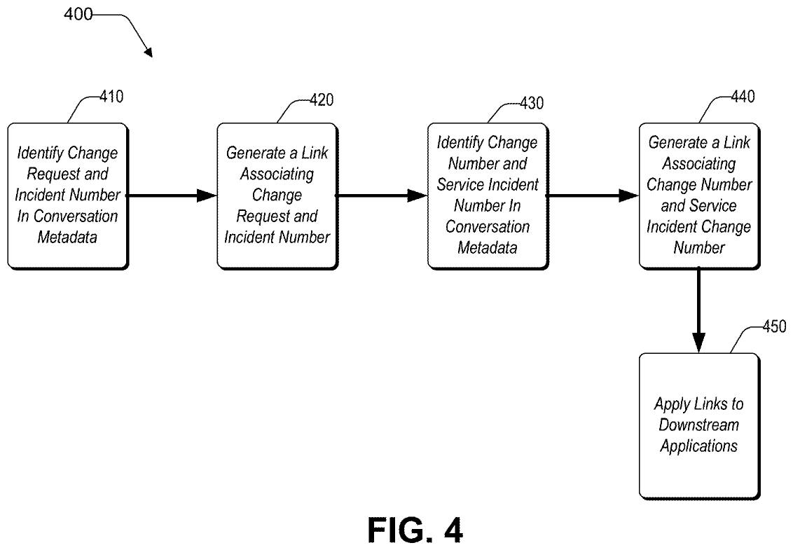

FIG. 4 shows a method 400 linking change incident data via explicit identification of objects in electronic conversations according to an embodiment. Actions in the method 400 may be performed generally by a computer processor operated software application or module (for example, the change incident linkage and risk assessment engine 240). The method 400 may be applicable to conversations that include a change request and an incident number in the text content of the conversation. The change request and incident number may be identified 410 in the conversation's text metadata. Some embodiments may identify specific formatted fields in the conversation. For example, the change request number (which may have a format that looks like “chg xxx”) may be mined from conversation data fields (e.g. name, name_nomalized, purpose). The incident number (which may have a format that looks like “incxxx”) may be mined from conversation data fields (e.g. name, name_nomalized, purpose). A link may be generated 420 associating the change request to the incident number.

For conversations with metadata that include a change number and service NOW incident number, the change number and service incident number may be identified 430 from the metadata. The change number may be mined from conversations (from fields such as “name/name_normalized”). The incident number may be mined from incident records having similar time ranges by analyzing the field “caused_by” if a change request number is present. A link may be generated 440 associating the change number and service incident number. The links may be stored and applied 450 to downstream applications.

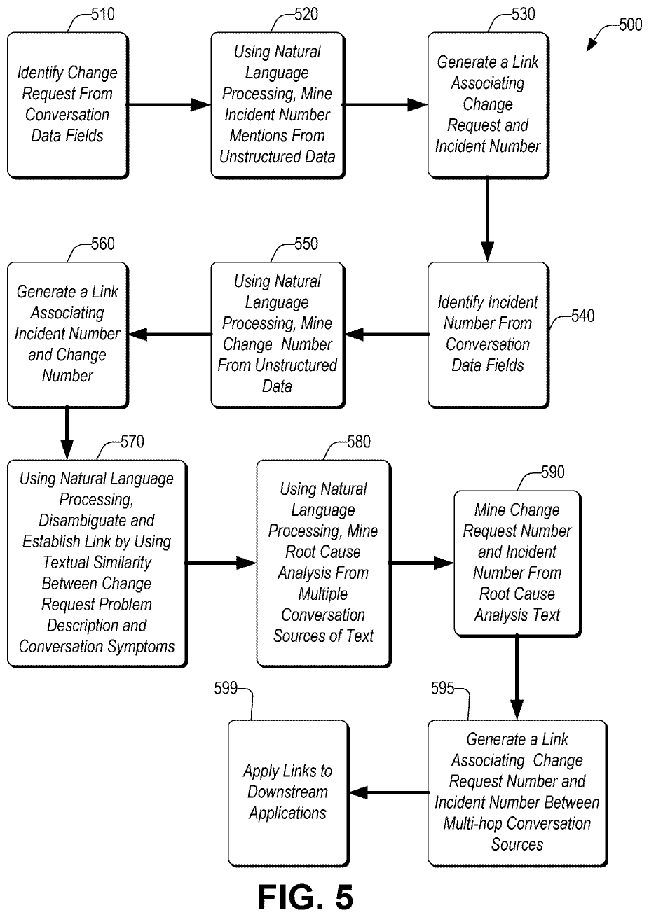

FIG. 5 shows a method 500 linking change incident data via implicit identification of objects in electronic conversations according to an embodiment. Actions in the method 500 may be performed generally by a computer processor operated software application or module (for example, the change incident linkage and risk assessment engine 240). The method 500 may be used when conversation data has unstructured text (i.e., data is not formatted or tagged as a pre-defined field). For example, when conversation metadata includes a change request number explicitly, but an incident number is included as unstructured text, the change request number (which may have a format that looks like “chg xxx”) may be mined from conversation data fields (e.g. name, name_nomalized, purpose). Incident number mentions (“incxxx”) may be mined 520 from conversation message text using, for example, natural language processing methods.

In some embodiments, identifying incident number mentions can be indiscriminate to incident resolution or to an incident causing the change. A link may be generated 530 associating the change request to the incident number. When conversation metadata includes an incident number explicitly but, the conversation includes a change request number as unstructured text, the incident number (which may have a format that looks like “incxxx”) may be identified 540 directly from conversation data fields (e.g. name, name_nomalized, purpose). The change number mentions (“chgxxx”) may be mined 550 from the text of a conversation message using, for example, natural language processing methods. A link may be generated 560 associating the change request to the incident number.

When the conversation metadata and conversation content does not include a change request, the conversation text content may be disambiguated 570 for meaning by identifying a textual similarity between a change request problem description and conversation symptoms present in the conversation text using natural language processing based similarity methods. The disambiguation may be used to identify a potential change request using natural language processing. Some embodiments include establishing links through multi-hop conversations. For example, when multi-hop conversations include root cause analysis information in unstructured text, the root cause analysis information may include a change request number and/or a service incident number. Natural language processing may be performed 580 to mine root cause analysis information from multiple sources (i.e., multi-hop) of conversation text. The change request number and service incident number may be mined 590 from the root cause analysis information found in multi-hop sources. A link associating the change request number to the incident number may be generated 595. The links found through implicit detection of change request associated information may be applied 599 to downstream applications.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A non-transitory computer readable storage medium tangibly embodying a computer readable program code having computer readable instructions that, when executed, causes a computer device to carry out a method of linking change incident data in an enterprise computing system, the method comprising:
receiving one or more electronic conversations associated with an issue in the enterprise computing system;
identifying a change request in the one or more electronic conversations;
identifying an incident number in the one or more electronic conversations;
generating a first link associating the change request to the incident number; and
applying the first link to a downstream application.

2. The non-transitory computer readable storage medium of claim 1, wherein the method further comprises:
identifying a change number in the one or more electronic conversations;
identifying a service incident number in the one or more electronic conversations;
generating a second link associating the change number to the service incident number; and
applying the second link associating the change number to the service incident number to the downstream application.

3. The non-transitory computer readable storage medium of claim 1, wherein the method further comprises:
identifying the change request, from conversation data fields in the one or more electronic conversations; and
using natural language processing, mining the incident number, from unstructured text in the conversation data fields.

4. The non-transitory computer readable storage medium of claim 1, wherein the method further comprises:
identifying the incident number, from conversation data fields in the one or more electronic conversations;
mining a change number from unstructured text in the conversation data fields, using natural language processing;
generating a second link associating the change number to the incident number; and
applying the second link associating the change number to the incident number to the downstream application.

5. The non-transitory computer readable storage medium of claim 1, wherein the method further comprises:
upon a determination that the one or more electronic conversations do not include the change request, identifying a change request problem description of the issue and a symptom of the issue from conversation data fields in the one or more electronic conversations; and
disambiguating between words used in the change request problem description and words used in the symptom to identify a potential change request by using natural language processing.

6. The non-transitory computer readable storage medium of claim 1, wherein the method further comprises:
retrieving the one or more electronic conversations from a plurality of conversation sources of text; and
identifying whether the one or more electronic conversations include a root cause analysis content in unstructured text.

7. The non-transitory computer readable storage medium of claim 6, wherein the method further comprises:
mining the root cause analysis content from the plurality of conversation sources of text using natural language processing;
mining a change request number and the incident number from the root cause analysis content; and
generating a second link associating the change request number and the incident number between the plurality of conversation sources of text.

8. A computer implemented method for linking change incident data in an enterprise computing system, comprising:
receiving one or more electronic conversations associated with an issue in the enterprise computing system;
identifying a change request in the one or more electronic conversations;
identifying an incident number in the one or more electronic conversations;
generating a first link associating the change request to the incident number; and
applying the first link to a downstream application.

9. The method of claim 8, further comprising:
identifying a change number in the one or more electronic conversations;
identifying a service incident number in the one or more electronic conversations;
generating a second link associating the change number to the service incident number; and
applying the second link associating the change number to the service incident number to the downstream application.

10. The method of claim 8, further comprising:
identifying the change request from conversation data fields in the one or more electronic conversations; and
mining the incident number, from unstructured text in the conversation data fields using natural language processing.

11. The method of claim 8, further comprising:
identifying an incident number from conversation data fields in the one or more electronic conversations;
mining a change number, from unstructured text in the conversation data fields using natural language processing;
generating a second link associating the change number to the incident number; and
applying the second link associating the change number to the incident number to the downstream application.

12. The method of claim 8, further comprising:
upon a determination that the one or more electronic conversations do not include a change request,
identifying a change request problem description of the issue and a symptom of the issue from conversation data fields in the one or more electronic conversations; and
disambiguating between words used in the change request problem description and words used in the symptom to identify a potential change request using natural language processing.

13. The method of claim 8, further comprising:
retrieving the one or more electronic conversations from a plurality of conversation sources of text; and
identifying whether the one or more electronic conversations include a root cause analysis content in unstructured text.

14. The method of claim 13, further comprising:
mining the root cause analysis content from the plurality of conversation sources of text, using natural language processing;
mining a change request number and the incident number from the root cause analysis content; and
generating a second link associating the change request number and the incident number between the plurality of conversation sources of text.

15. A computing device configured to link change incident data in an enterprise computing system, comprising:
a processor;
a storage device coupled to the processor;
an engine stored in the storage device, wherein an execution of the engine by the processor configures the computing device to perform acts comprising:
receiving, by the change incident computing engine, one or more electronic conversations associated with an issue in the enterprise computing system;
identifying a change request in the one or more electronic conversations;
identifying an incident number in the one or more electronic conversations;
generating a first link associating the change request to the incident number; and
applying the first link to a downstream application.

16. The computing device of claim 15, wherein the execution of the engine further configures the computing device to perform acts comprising:
identifying a change number in the one or more electronic conversations;
identifying a service incident number in the one or more electronic conversations;
generating a second link associating the change number to the service incident number; and
applying the second link associating the change number to the service incident number to the downstream application.

17. The computing device of claim 15, wherein the execution of the engine further configures the computing device to perform acts comprising:
identifying the change request, from conversation data fields in the one or more electronic conversations; and
mining the incident number, from unstructured text in the conversation data fields, using natural language processing.

18. The computing device of claim 15, wherein the execution of the engine further configures the computing device to perform acts comprising:
identifying an incident number, from conversation data fields in the one or more electronic conversations;
mining a change number, from unstructured text in the conversation data fields, by using natural language processing;
generating a second link associating the change number to the incident number; and
applying the second link associating the change number to the incident number to the downstream application.

19. The computing device of claim 15, wherein the execution of the engine further configures the computing device to perform acts comprising:
upon a determination that the one or more electronic conversations do not include a change request;
identifying a change request problem description of the issue and a symptom of the issue from conversation data fields in the one or more electronic conversations; and
disambiguating between words used in the change request problem description and words used in the symptom to identify a potential change request, by using natural language processing.

20. The computing device of claim 15, wherein the execution of the engine further configures the computing device to perform acts comprising:
retrieving the one or more electronic conversations from a plurality of conversation sources of text;
identifying whether the one or more electronic conversations include a root cause analysis content in unstructured text;
mining the root cause analysis content from the plurality of conversation sources of text, by using natural language processing;
mining a change request number and the incident number from the root cause analysis content; and
generating a second link associating the change request number and the incident number between the plurality of conversation sources of text.
